(19) United States
(12) Patent Application Publication
(10) Pub. No.: US 2015/0106118 A1
(43) Pub. Date: Apr. 16, 2015

(54) Cloud-Based Storage and Retrieval of Medical Information Using Near Field Communication Devices

(71) Applicants: Christopher A. Melo, Johnston, RI (US); Angelo A. Pitassi, JR., Cranston, RI (US)

(72) Inventors: Christopher A. Melo, Johnston, RI (US); Angelo A. Pitassi, JR., Cranston, RI (US)

(21) Appl. No.: 14/190,930

(22) Filed: Feb. 26, 2014

Related U.S. Application Data
(60) Provisional application No. 61/769,799, filed on Feb. 27, 2013.

(51) Int. Cl. G06F 19/00; H04B 5/00

(52) U.S. Cl. CPC G06F 19/323; H04B 5/0031
USPC 705/3

(57) ABSTRACT

Systems and methods for using near field communication in a cloud computing environment to store and retrieve medical information are provided.

### REFERENCE TO RELATED APPLICATIONS

This application claims the benefit of U.S. Provisional Application No. 61/769,799 filed 27 Feb. 2013.

### FIELD OF THE INVENTION

The invention is in the field of medical information storage and retrieval.

### BACKGROUND OF THE INVENTION

If a medical emergency occurs, quick action can be important to save lives and ameliorate injuries. If an emergency medical technician is unable to obtain basic medical information from the patient, for example, because the patient is unconscious, the lack of information may impair the technician's ability to provide effective medical treatment.

Portable medical record systems are known in the art. Many make use of cellular phone communications to retrieve medical data. See for example, United States Patent Publication US 2003/0220822 in the name of Fiala et al.

Some involve using near field communication (NFC). NFC is a short-range wireless connectivity technology. NFC can be used with a variety of devices, including mobile phones and/or other portable electronic devices transferring information. NFC operates using magnetic field induction at a frequency of, for example, 13.56 MHz and transferring data at up to 424 Kbits/second. NFC provides both read and write exchange of data between electronic devices. Communication can be initiated by bringing two NFC-enabled devices in close proximity. The communication between two NFC-compatible devices occurs when the devices are positioned, for example, within about four centimeters of one another.

As an example, a motion or touch by a user with a device can establish an NFC connection. NFC communication technology operates according to accepted standards, such as International Standards Organization (ISO) and/or other telecommunications standards, for example. Due to the short transmission range, NFC-enabled transactions provide increased security.

There are a number of prior art disclosures relating to the use of NFC in medical record storage and retrieval and medical measurement transmission. The following patents and patent publications relating to NFC are exemplary. They are hereby incorporated by reference for the substance of their disclosures.

United States Patent Publication US 2009/0248437 in the name of Gucciardi discloses an on-demand medical record system using NFC that includes a NFC storage device adapted to retrieve patient medical data for storage on the storage device and a NFC retrieval device adapted to engage in NFC with the NFC storage device. United States Patent Publication US 2008/0281217 in the name of Peterson et al. discloses a medical diagnostic/monitoring system that includes a data acquisition device having a first NFC device and a data storage device wirelessly connected to the data acquisition device and including a second NFC device. The two NFC devices are collectively configured to wirelessly transfer data from the acquisition device to the storage device. United States Patent Publication US 2010/0168605 in the name of Aarts discloses the use of NFC in transmitting data from a medical measurement device to a receiving device. United States Patent Publication US 2011/0185178 in the name of Gotthardt discloses the use of NFC in communicating patient data from an electronic health insurance card to a reading device. United States Patent Publication 2010/0004950 in the name of Bajko et al. discloses a system and method using mobile telephones for creating documents containing medical-related information, storing the document on the phone and using the phone to transmit the document to a NFC reader.

The disadvantages with the foregoing systems is that patient or user data is stored on a device and therefore, if the device is lost or broken, the information can be lost as well. Another disadvantage with the foregoing systems is that the medical information may not be current. The user must constantly upload new data. Further, with some wearable medical I.D. systems, the patient or user is limited to only a few lines of data. Complete records cannot be stored.

These and other disadvantages are eliminated or ameliorated by the methods and systems of the invention as summarized and described in detail below.

### SUMMARY OF THE INVENTION

The invention includes computer-implemented systems, and methods, and a computer program product and a computing device for the storage and transmittal of medical records and medical information and data (hereinafter referred to as ‘records’) using cloud computing. Cloud computing is well known in the art. See for example United States Patent Publications 2011/0179286 and 2013/0275486, U.S. Pat. Nos. 8,532,108, 8,495,611, 8,589,372 and 8555381, and WO Patent Publication 2013/177246, all of which are herein incorporated by reference for the substance of their disclosures. Cloud computing refers to distributed computing in a large network, like the internet, in which shared resources, software, and information are provided to computers and other devices upon demand. Methods of storing personal and sensitive information such as medical records within the cloud are also known in the art.

By storing medical data and information within a secure cloud-based portal, complete medical records can be made accessible, including for example, MRI results, x-rays, and the like. The data is not stored on a device so it cannot be lost and it is constantly current, as medical personnel can access the portal and upload the information in real-time.

The system includes a mobile device that is adapted to receive patient medical information and data that is securely stored within the cloud. In a preferred embodiment, the mobile device is a near field communication (NFC) device. In another embodiment, the mobile device is a NFC enabled cell phone, a NFC enabled laptop computer, a NFC enabled tablet, notebook or sub-notebook computer, a NFC enabled personal digital assistant, a NFC enabled smart phone, a NFC enabled pocket computer, a NFC enabled wearable computer or the like. This mobile device is operable to receive patient medical information stored within the cloud only under certain circumstances, specifically only when brought into NFC range of a means of authorizing access to the patients' medical records stored in the cloud. Accordingly, the system also includes one or more NFC authorization means that function to identify the patient and authorize access to the database. The authorization means are adapted to transmit a unique, assigned, identification code to an NFC device capable of receiving the code, specifically one or more of the mobile devices set forth above. The NFC authorization device is wearable and may take the form of a bracelet or pendant, for example. Alternatively, the NFC authorization device may be a wallet sized card for example that the patient carries. This wearable NFC identity device functions, in effect, as a key, which unlocks the patient medical information and data that is securely stored within the cloud. NFC technology involves a NFC chip/tag and a data connected NFC-enabled reader brought together in close proximity to transfer information or in this scenario, trigger an exchange of data from a secure cloud based system. Positioning the device in close proximity to the wearable NFC identity device provides an added benefit of increased security of close proximity of the transmission and is an improvement over other radio wave technology.

The medical information to be stored may be inputted by the user of the system, i.e. the patient, or by another with the permission of the patient. To do so, the patient accesses a health profile provider internet site. The health profile provider internet site provides a secure mobile and web interface for users to input information. This user inputted information is maintained in a medical profile that is stored securely within the cloud. Through the provided interface, users are instructed to input information such as, for example, chronic medical conditions, allergies, medications, wellness management, document management and contacts. In all data input fields the user has the ability to decide what information they would like to be visible to medical personnel during a medical emergency. This option is displayed with a “NO do not show it” checkbox for username/password access only or a “YES show it” checkbox which represents a viewable read only display on the authorized device. Any and all fields displaying this “YES show it” checkbox will be accessible and visible to a first responder, an emergency medical technician, a clinician, and/or other hospital staff/person with a near field communication (NFC) device adapted to receive to information and data. In this manner, users are in complete control of their medical and personal information.

Users are assigned a unique identification code (a HIP Code) located on each of their wearable NFC identity devices. The user then securely registers their unique identification code (HIP Code) online at the website of the health profile service provider using their mobile or any other internet connected device as each unique identification code (HIP Code) is associated to the users specific HealthID account. As described above, in an emergency scenario, the NFC device operable to receive patient medical information stored within the cloud may be used to retrieve all or part of a patient medical history from the individual's data connected NFC enabled wearable device.

As will be described further below, a user's medical information can be read on a data-connected mobile device and/or other similar portable device after being retrieved using one of several transfer options available.

The input device may be an internet connected computer and/or other data input device for input of user information. The NFC reader device may be a smart phone, personal tablet, and/or other handheld communication device. The NFC wearable device may be a medical ID bracelet or watch, a necklace or pennant, wallet card and piece of wearable apparel.

The NFC reader can communicate with the NFC wearable device via near field communication to retrieve user information stored within the secure cloud based portal. Some or all of the personal information stored on secure cloud service may be read without authorization for emergency purposes. The authorization is made by the user using the lock and unlock feature within the secure cloud based application, for example, the patient or a medical administrator. Examples of personal information that may be accessed without authorization may include: patient name, address, patient contact information, medications and allergies.

User information that can be input with the secure portal or mobile device may include, for example, one or more of the following pieces of information: patient name, user contact information, emergency contact information, insurance information, billing information, primary care doctor information, specialist information, drug/prescription information, allergy information, current medication information, and a patient identifier. Users also have the ability to input data into a wellness input section to track the users overall health management. User information may also include user records and reports. In addition, user information may also include, for example, biographical information, medical history, family history, genetic test results, blood test results, heart rate, blood pressure, blood flow, and biomarker presence information. The user identifier may be unique, for example, within a network or globally. Blood test results may include, for example, test results for blood oxygen level, white blood cell count, complete blood count, thyroid, cardiac risk factors, cholesterol, proteins, PSA (prostate), waste products, and glucose. Also user information may come from multiple sources. For example, user information may come from one or more of the user, an insurance company, an in network healthcare provider, and an out-of-network healthcare provider.

In another embodiment, the system and method can be adapted for use in an in-patient medical facility care such as in-patient hospital, hospice, assisted living, and rehabilitative care. In this embodiment, as a care provider holding the NFC enabled device moves around a hospital, the NFC enabled device can tap an NFC identity device worn by a patient to obtain care information for the patient being visited by the care provider. For outpatient care, if the range of the device is configured to be a physician's waiting area, the device can download from the cloud the patient's medical information. For identifiable users entering an emergency room, the device may save data access time.

The foregoing summary as well as the following detailed description will be better understood when read in conjunction with the appended drawings.

### BRIEF DESCRIPTIONS OF THE DRAWINGS

FIG. 1 is a flow chart illustrating the cloud-based on-demand portable medical record system and workflow in accordance with the invention.

FIG. 2 illustrates an NFC identity device portion of the invention that can be worn or carried by the patient.

FIG. 3 is a screenshot reproduction of the homepage of healthid.com, one embodiment of the mobile/web-based patient portal in accordance with the invention.

FIG. 4 is a screenshot reproduction of the login page of the healthid.com embodiment of the invention.

FIG. 5 is a screenshot reproduction of the My Health dashboard page of the healthid.com embodiment of the invention.

FIGS. 6-10 are screenshot reproductions of various pages in the healthid.com embodiment in which a user complete various operations as described in the Detailed Description.

### DETAILED DESCRIPTION OF THE INVENTION

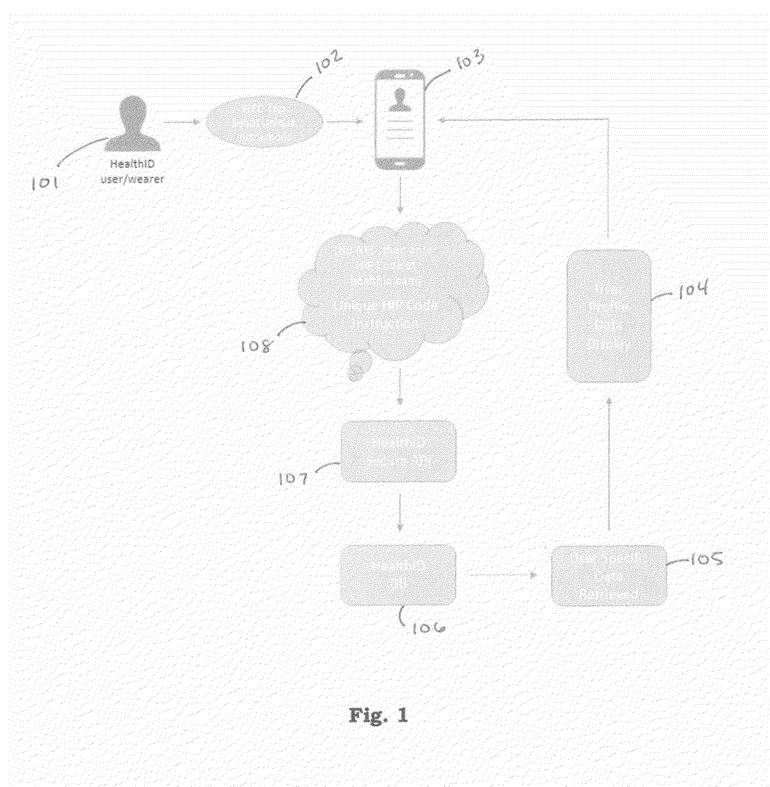

Referring now to FIG. 1, there is illustrated a flow chart of the cloud-based on-demand portable medical record system and workflow in accordance with the invention. Medical data is stored in a database (HealthID DB) within the cloud, which is defined as follows by the National Institute of Standards and Technology. First, it is on-demand and self-service. In other words, the user of cloud computing services unilaterally provisions computing capabilities, such as server time and network storage, on an as needed basis automatically without requiring human interaction with each service provider. On-demand self-service allows users to obtain, configure and deploy cloud services themselves using cloud service catalogues, without requiring the assistance of IT. Infrastructure vendors have created cloud computing templates, which are obtained from cloud service catalogues. Some manufacturers of such templates or blueprints include BMC Software, Hewlett-Packard, RightScale and Red Hat. The templates contain configurations used to set up cloud services and provide the technical information necessary to build ready-to-use clouds. Each template includes specific configuration details for different cloud infrastructures and also includes the predefined web service, the operating system, the database, security configurations and load balancing. The templates can be used to move applications between clouds via a portal as they define all that an application requires to run in different environments. For example, a template could define how the same application could be deployed in cloud platforms based on Amazon Web Service, VMware or Red Hat. Second cloud computing has broad network access. Computing capabilities are available over the network and are accessed through standard mechanisms that promote use by a variety of platforms, for example, by mobile phones, tablets, laptops, and workstations. Third, it makes use of resource pooling. The network provider's computing resources are pooled to serve multiple consumers using a multi-tenant model, with different physical and virtual resources dynamically assigned and reassigned according to consumer demand in real time. Fourth, cloud computing is elastic. The capabilities of the network can be provisioned and released to scale rapidly outward and inward commensurate with demand. To the user of the service, the capabilities available for provisioning appear unlimited and can be appropriated in any quantity at any time. Fifth, cloud systems use a “measured service” model. They automatically control and optimize resource use by leveraging a metering capability at some level appropriate to the type of service (e.g., storage, processing, bandwidth, and active user accounts). Resource usage is monitored, controlled, and reported, providing transparency for both the provider and consumer of the utilized service.

Cloud computing providers offer their services via several different models: infrastructure as a service (IaaS), platform as a service (PaaS), and software as a service (SaaS), anything as a service (XaaS), network as a service (NaaS) and communication as a service (CaaS) are exemplary. For the purpose of this invention, the choice of model is unimportant and any model may be employed.

Exemplary cloud computing service providers include Amazon Web Services (AWS), Google, Microsoft, IBM, Apple, Rackspace, EngineYard, dotCloud, Savvis, Softlayer Technologies Inc., EMC, Profit Brick, Navisite Cloudsigma, and Heroku. Any one of these providers may be employed in the methods and systems of this invention.

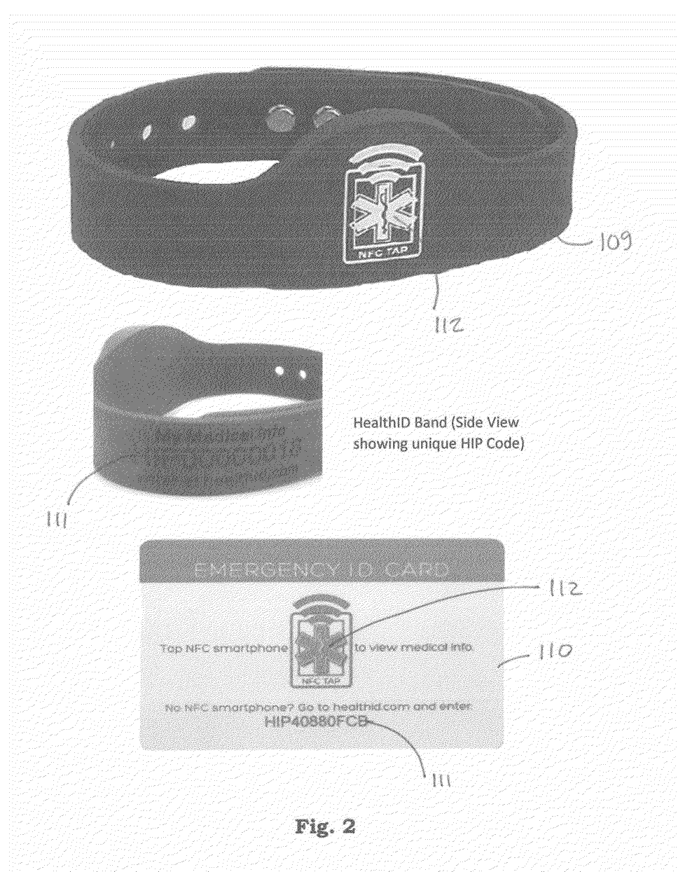

Once the cloud computing structure is in place, medical data can be entered, either by the patient or by medical personnel. Such data will be stored in a Profile Data Display. Access to the data is accomplished through the website portal connected to the cloud by entry of an assigned HIP code (HIP code entered via HealthID.com in the described embodiment). The HIP Code and website portal can be accessed by a desktop, laptop or notebook computer or by a mobile device, such as an electronic device in the form of a mobile telephone, a combination personal digital assistant (PDA) and mobile telephone, a smart phone, a PDA, an integrated messaging device. It can be accessed whether the access device has near field communication reader capability or not. In FIG. 1, the device is a mobile telephone, 103, with near field communication reader capability. The data base, 106, is accessed by tapping phone 103 to the HealthID User's, 101, authorization device worn, for example, on the User's wrist, an example of which is shown in FIG. 2. The tap, 102, transmits the User's unique HIP Code from the identity device to the mobile device, enabling the user, 101, of the mobile device, 103, to access the User's data, 106, via the HealthID internet portal. The box, 105, described as “Data Retrieved” in FIG. 1 represents the information retrieved from the secure database, HealthID DB 106. It is here that the information stored in the database is decrypted for display. The Secure API, 107, is the public interface that allows the connection from an authorized device that has processed the secure HIP code, or token, either by manual input, 108, or by NFC input, 103. Once the user specific data is retrieved (step 105), it is displayed, 104, on the mobile device 103.

Referring now to FIG. 2, there is shown two different embodiments of the authorization means of the invention, a wearable wristband 109 and an emergency ID card 110. Each embodiment is provided with a unique HIP Code consisting of a series of letters and numbers 111 and an NFC chip 112. The code is required in order to access the patient's medical information in the absence of an NFC enabled device (FIG. 1, step 108). The NFC chip transmits the Code automatically to an NFC enabled device (like the smart phone 103 in FIG. 1) in order to access the patient's medical information. The wristband 109 may be made of any suitable material that is able to retain both the HIP Code 111 and the NFC chip 112. In the illustrated embodiment, the wrist band is a flexible plastic, the NFC chip 112 is embedded within it and HIP Code 111 is stamped in a permanent ink on the surface of the band. Alternatively, HIP Code may be etched into or embossed onto a portion of the wristband. It is preferred that NFC chip 112 is embedded within the band in order to protect it from damage. In the second embodiment, the authorization means comprises a wallet-sized emergency ID card that bears HIP Code 111 and contains NFC chip 112. A relatively rigid plastic, similar to those used form credit cards, is the preferred material for this.

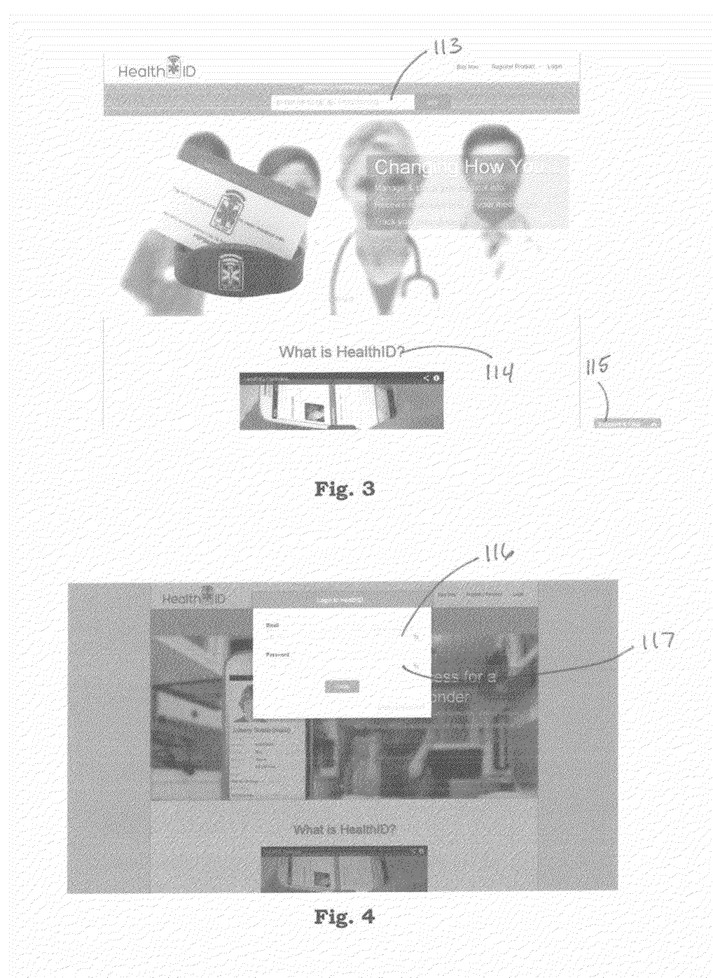

Referring now to FIG. 3, a screen shot reproduction of the homepage of the healthid.com embodiment of the invention is shown. This is the patient portal into the system. At 113, the patient's unique HIP Code (identifier) is entered to access the viewable medical information. Clicking on 114 brings up a video tutorial that shows and explains the HealthID products and features. A support and frequently asked questions page can be accessed by clicking on 115.

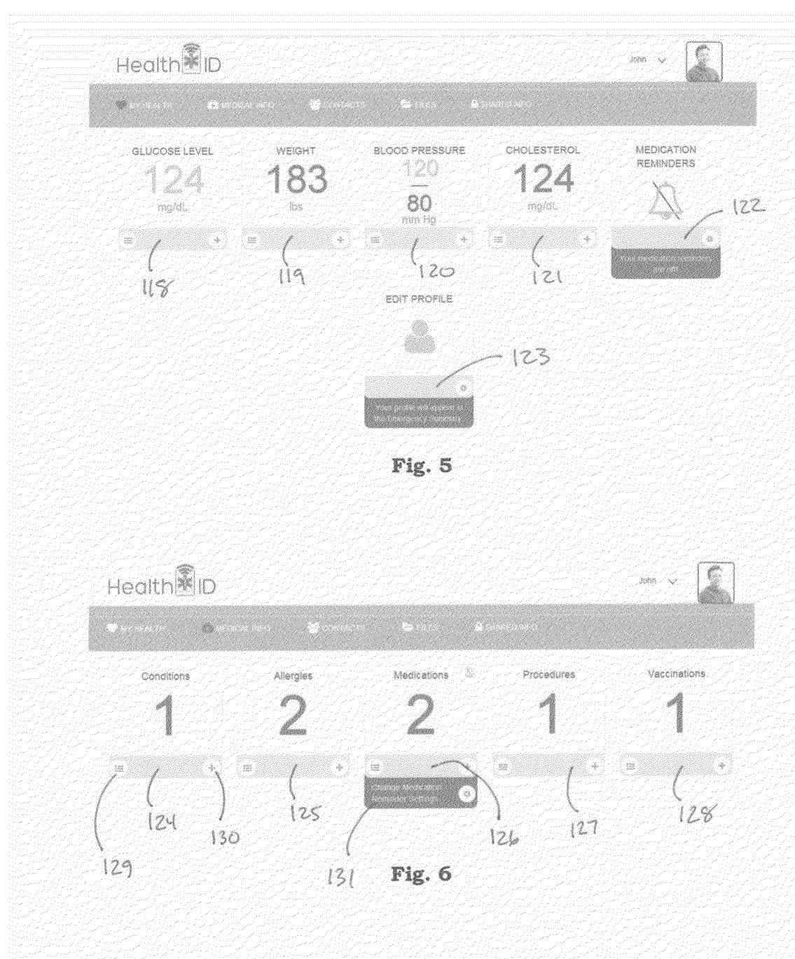

FIG. 4 shows the login page of the system of the invention. An established user name, the user's email address is entered at 116 and the user's password is entered at 117. In this manner the user's account can be accessed.

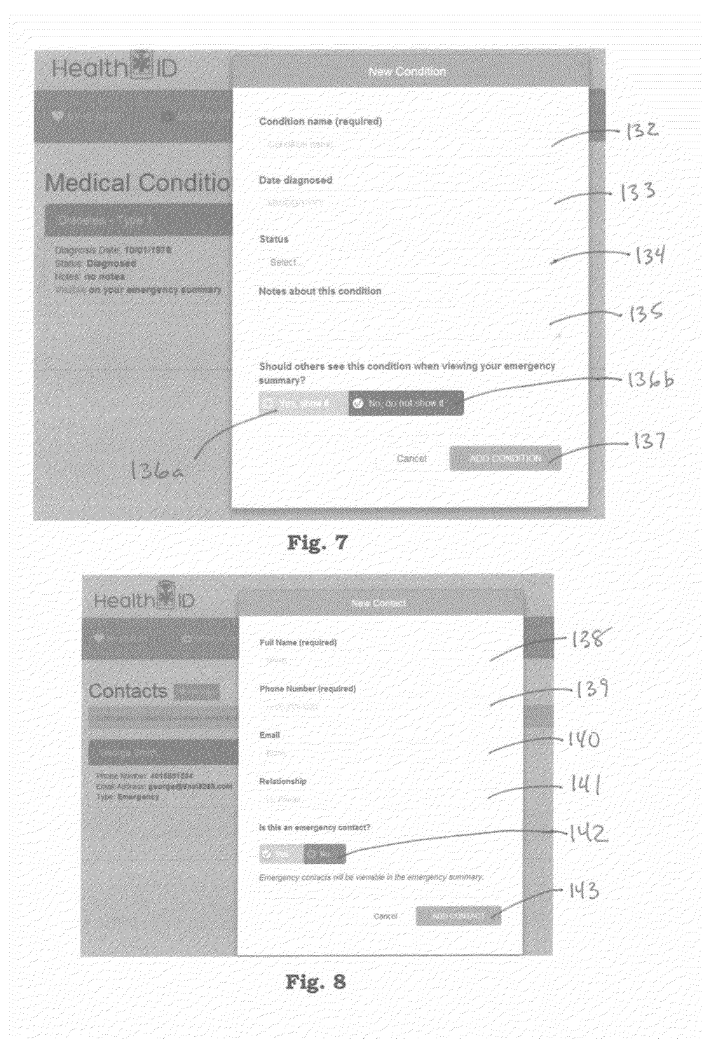

FIG. 5 shows the first landing page of the system of the invention that appears upon entry of the required data on the login page as described in relation to FIG. 4. This dashboard page provides a quick summary of chronic health information that can be updated, tracked in a log format, and viewed as a graph. This track able basic information can comprise, for example, blood glucose level, 118, weight, 119, blood pressure, 120, cholesterol, 121, and medication reminders, 122. In addition, the user can add/update/edit basic profile data such as height, eye color, blood type, profile image, etc. To do so, the patient would click on the edit profile tab, 123.

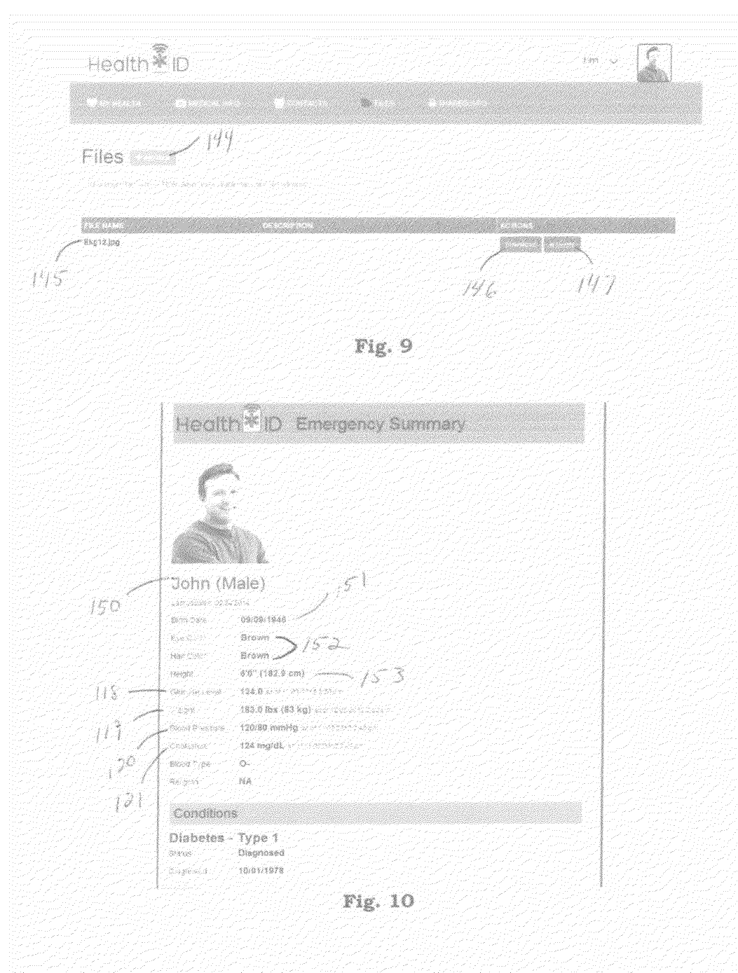

FIG. 6 shows a page of the system of the invention where the user or patient can add or update their medical information. The information may be broadly classified as conditions, 124, allergies, 125, medications, 126, procedures, 127 and vaccinations, 128. Under each classification, to see a list of the information currently stored, the user or patient would click on the list icon, 129. To add information, the user would click on the plus (+) icon, 130. The function at 131 allows the user to modify medication reminders.

FIG. 7 shows a page of the system of the invention illustrating a feature of the invention where the user or patient can determine which medical data she or he wants medical personnel to be able to view. Specifically, a descriptor of the medical condition is entered at 132, for example, Type I diabetes. The date the user was diagnosed may be entered at 133 and the status of the condition may be entered at 134. Additional information about the condition may be entered at 135 and either “Yes show it”, 136a, is clicked or “No, do not show it”, 136b, is clicked. To enter the data and the instruction to either show or not show the data box 137 “ADD CONDITION” is clicked by the user.

FIG. 8 shows a page of the system of the invention where a user can enter emergency contact information, by name at box 138, phone number at box 139, and email address at box 140. The relationship to the user or patient can be entered at box 141 and the contact can be listed as either an emergency contact or not at 142. To add the contact into the system box 143 can be clicked.

FIG. 9 shows a page of the system of the invention where the patient (i.e. the user) can upload documents such as MRI results, x-ray films, insurance care information and the like. To add a new file/document into the system, box 144 can be clicked. To manage an existing file in the system, 145, the user would simply click on box 146 to download and open the existing file or click on 147 to remove it.

FIG. 10 shows the first page of the system of the invention that a first responder would see if they either use a NFC enabled reader to access the cloud-stored patient's medical information or access the site from an internet connected mobile device and manually enter the patient's unique HIP Code. The patient's basic information is provided such as name and sex, 150, birth date, 151, and physical information such as eye color and hair color, 152, height, 153, and the other data from the landing page shown in FIG. 5: glucose level 118, weight 119, blood pressure 120 and cholesterol 121. In this example, the patient's Type I diabetes is also shown as a condition because when the patient/system user entered the data on this condition, she or he clicked the “Yes, show it” button on the New Condition page as shown in FIG. 7.

Among other things and as illustrated above, using cloud based storage and retrieval and NFC technology for accessing a patient's medical history and information provides time savings in emergency and other critical situations and helps improve accuracy and completeness of the information. The system can help to reduce the amount of paper work a patient is required to fill out before being seen because the information may be automatically uploaded to the emergency responders computer from the cloud-based storage site.

The components, elements and functionality of the pages, interfaces, and screens described above may be implemented alone or in combination in various forms of hardware, firmware and/or as a set of instructions in software. The invention should not be construed as limited to the features shown therein.

What is claimed is:

1. A cloud-based storage and retrieval system for medical information comprising:
a. a computer enabled data-base containing the medical information that is stored in a cloud computing environment;
b. a near field communication (NFC) enabled mobile device adapted for accessing the database; and
c. authorization means for authorizing the accessing means to access the database via the NFC enabled device.

2. The system according to claim 1 wherein the NFC enabled mobile device is selected from the group consisting of an NFC enabled cell phone, a NFC enabled smart phone, a NFC enabled laptop computer, a NFC enabled tablet computer, a NFC enabled notebook computer, a NFC enabled sub-notebook computer, a NFC enabled pocket computer and a NFC enabled wearable computer.

3. The system according to claim 2 where the mobile device is operable to receive patient medical information stored within the cloud only when brought into NFC range of the authorization means.

4. The system according to claim 3 wherein the authorization means comprises a wearable device containing an NFC chip adapted to transmit a unique, assigned, identification code to an NFC enabled mobile device capable of receiving the code.

5. The system according to claim 4 wherein the wearable device is a bracelet.

6. The system according to claim 3 wherein the authorization means comprises a wallet sized card containing an NFC chip adapted to transmit a unique, assigned, identification code to an NFC enabled mobile device capable of receiving the code.

7. The system according to claim 1 wherein the computer enabled data-base is maintained in a unique medical profile stored in the cloud and accessible via a secure internet site user interface that permits input and retrieval of a patient's medical information.

8. The system according to claim 7 wherein the medical information that can be input and retrieved includes any one or more of patient name, user address, user contact information, emergency contact information, insurance information, billing information, primary care doctor information, specialist information, drug/prescription information, allergy information, current medication information, biographical information, medical history, family history, genetic test results, blood test results, heart rate, blood pressure, blood flow, biomarker presence information, test results for blood oxygen level, white blood cell count, complete blood count, thyroid, cardiac risk factors, cholesterol, proteins, PSA (prostate), waste products, and glucose.

9. A method for storing a patient's medical information in a cloud-based computing environment comprising:
a. providing a website portal to a computer database stored in cloud computing structure;
b. accessing the database via a website;
c. entering the patient's medical information into the database in a profile data display; and
d. assigning a unique access code to the profile data display.

10. The method according to claim 9 where access to the medical information is accomplished by entry of the assigned access code into the website portal.
